(19) United States
(12) Patent Application Publication
(10) Pub. No.: US 2022/0053715 A1
(43) Pub. Date: Feb. 24, 2022

(54) VERTICAL HYDROPONICALLY PLANT-GROWING TOWER SYSTEM

(71) Applicant: VERTICANNA LTD., Mishmar Hashiva (IL)

(72) Inventors: Roy SHAY, Kfar Shmuel (IL); Dan MEIMERON, Mishmar Hashiva (IL); Yoav ZEIF, Tel Aviv (IL)

(21) Appl. No.: 17/299,341

(22) PCT Filed: Dec. 2, 2019
(86) PCT No.: PCT/IL2019/051321

§ 371 Date: Jun. 3, 2021

Related U.S. Application Data
(60) Provisional application No. 62/774,496, filed on Dec. 3, 2018.

(51) Int. Cl. A01G 31/02

(52) U.S. Cl. CPC A01G 31/02; A01G 2031/006

(57) ABSTRACT

The present invention provides hydroponic plant growing vertical towers and systems, and methods of growing plants using them for improved and consistent plant yields.

### FIELD OF THE INVENTION

The present invention relates in general to hydroponic plant growing, in particular vertical towers system that both improves yield consistency and quantity while saving room, costs and labor.

### BACKGROUND OF THE INVENTION

Hydroponics is a method of growing plants using mineral nutrient solutions, in water, without soil. A hydroponic garden usually includes a tray/pot for holding and growing a plant(s), a water reservoir, and preferably a pump for circulating the water from the water reservoir and the tray/pot. In order to minimize growing space, hydroponic garden towers have been developed, with one or more columns of cups/pots for growing plants. However, known hydroponic towers have various disadvantages, such as inability to circulate the water lack of rigidity which requires support (e.g. wall) and prevent the possibility of growing large plants; large weight which prevent movement of the tower(s) from place to place (e.g. to follow the sun); and inadequate lighting, etc.

Other disadvantages of various known towers include: (i) using light sources that are uncapable of generating sufficient flower or fruit yields, without placing them relatively far from the plants, which requires using a high energy consuming light source as well as cooling systems, to enable plants to grow; (ii) correlating various light intensities, compositions, and durations, during the different growing stages (e.g. no dimming or using various light intensities and wavelengths); and (iii) circulating irrigation water across commercial tower farms in an equal manner.

Accordingly, it is desirable to provide a hydroponic tower system that allows for low energy consuming, efficient production of plants, can be configured to different plants' sizes and heights, is structurally strong, equally recirculates water amongst the components of the system, and provides adequate light conditions in respect to the plants' different growing stages.

### SUMMARY OF INVENTION

The present invention provides a vertical hydroponically plant-growing tower system comprising: (i) a central water reservoir; (ii) a base unit comprising a water tank; (iii) a water-quality and water-flow control system/unit; (iv) a hollow tube connected to the base unit, said hollow tube having an opening at its top allowing air to enter the tube, and a bottom opening allowing the air to flow through the tube and onto the water within said water tank; (v) a first light source located within said hollow tube; (vi) a second light source associated/located onto each one of said one or more growing towers; (vii) at least one ventilation unit designed to push air through the upper opening of said hollow tube across said first light source and into said water tank; and (viii) one or more rotatable growing hollow towers having planting niches, each growing tower has a hording tank/reservoir at its top from which water flow over the inner wall of the tower across said planting niches, wherein said growing hollow towers can be rotated to thereby enable access to the planting niches located on all sides of the growing tower.

The present invention further provides a method for maximizing plant growth per square meter, the method comprising the steps of: (i) providing a tower system according to the invention; (ii) filling water in the water tank; (iii) placing/planting plants/seeds/cuttings within the planting niches; (iv) turning the tower system on to thereby: enable water flow from the water tank to the hording tank/reservoir; activating the light source(s); and activating the ventilation unit and the water chiller/heater; thereby enabling optimized plant growth per square meter.

The present invention further provides a method for germinating seeds using the vertical hydroponically plant-growing tower system of the invention.

### BRIEF DESCRIPTION OF DRAWINGS

FIG. 1 is a diagram illustrating the different components of an exemplary growing tower unit according to the invention.

FIGS. 2A-2B are illustrations of an exemplary growing tower system according to the invention: FIG. 2A is an upper view, and FIG. 2B is a side view.

FIGS. 3A-2D are HPLC graphs showing the active ingredient contents of four different plants: FIG. 3A is for a control plant grown in regular hydroponic system; and FIGS. 3B-3D are for three different plants grown by the tower system of the invention.

### DETAILED DESCRIPTION OF THE INVENTION

Standard plant growing, either in the ground or hydroponically, is space consuming since each plant needs to be separated from nearby plants in order to provide sufficient space for the roots and/or sunlight, and/or artificial light source to the leaves. Accordingly, several attempts have been made to grow plants vertically, i.e. in a growing tower. However, using soil in a tower is problematic due to the weight of the soil and limited soil space in each growing niche, and operative procedure required in order to replace the soil/add fertilizer across the tower system. Therefore, attempts have been made to use hydroponic growing towers. Nevertheless, such hydroponic growing towers suffer from other disadvantages, the main is insufficient light to the growing plants at the bottom of the tower, which leads to the use of powerful lamps that are both electricity consuming and heat generating. In addition, many known towers pose high probability of getting inconsistency of irrigation water to plants, i.e. some towers may be irrigated more than others, and some plants in the same tower may be irrigated more than others.

The present invention provides a vertical hydroponically plant-growing tower system that overcomes all the above mentioned drawbacks and more. Accordingly, the present invention provides a vertical hydroponically plant-growing tower system comprising: (i) a central water reservoir; (ii) a base unit comprising a water tank; (iii) a water-quality and water-flow control system/unit; (iv) a hollow tube connected to the base unit, said hollow tube having an opening at its top allowing air to enter the tube, and a bottom opening allowing the air to flow through the tube and onto the water within said water tank; (v) a first light source located within said hollow tube; (vi) a second light source associated/located onto each one of said one or more growing towers [e.g. strips of lamps around each tower]; (vii) at least one ventilation unit designed to push air through the upper opening of said hollow tube across said first light source and into said water tank; and (viii) one or more rotatable growing hollow towers having planting niches, each growing tower has a hording tank/reservoir at its top (i.e. located above the highest planting niche) from which water flow over the inner wall of the tower (i.e. within the hollow tower) across said planting niches (and through the roots of the plants in each niche), wherein said growing hollow towers can be rotated to thereby enable access to the planting niches located on all sides of the growing tower (and rotate back toward the light source located in between the towers).

In specific embodiments of the system of the invention, the water tank within the base unit constitutes the central water reservoir.

In certain embodiments, the system of the invention is portable, e.g. comprises wheels or other transporting elements (such as rails), thereby enabling moving the growing towers from place to place in order to optimize and control the growing space, and/or move the towers according to lighting. It should be noted that the movement of the tower may be manual, e.g. by pushing or pulling the tower from one point to the other, or robotic, e.g. operated by motor, e.g. electric motor that can be controlled by an operator or computer program.

In certain embodiments, the hydraulic process of the system of the invention comprises: (i) pushing water from a main water reservoir upwards through a feeding line to fill the upper hording tanks of each one of the hollow growing towers; (ii) dripping of the water from the hording tanks, by gravity forces, across the inner walls of the hollow growing towers and into the water tank at the base unit. In specific embodiments, the dripping water are first drained into the base unit reservoir, then drained into a collecting line and are then drawn, e.g. by a pump or gravity, through the water treatment unit (e.g. UV) and back into a central water reservoir. In other specific embodiments, the water tank at the base unit serves as a water collecting tank for treating the water, and then the water flow to a main (either external or internal) main water reservoir. In yet other embodiments, the main water tank in the base unit comprises two sections: a first upper section for collecting water dripping from the upper hording tank(s) and a second lower section serving as the main water reservoir, wherein water passing from the first section to the second pass through the water treatment unit. Notably, the water are flown upwards and back into the hording tank(s) for another irrigation cycle, via a water pump, optionally located at the lower section of the base unit reservoir.

In order to further save growing space, it is possible to use multiple tower systems of the invention. In such a case, it is possible to connect several tower systems to a single main water reservoir. Accordingly, in certain embodiments of the tower system of the invention, the water tank is designed to be connected to a nearby main water reservoir. In another embodiment, the water tank is designed to be connected to a water tank(s) of a nearby parallel tower system(s), and optionally also to a main water reservoir.

It should be noted that the quality of the water in the tower system of the invention needs to be monitored and maintained in order to facilitate optimal growth of the plants. It is known that if the water is too acidic or if there is insufficient oxygen or nutrients, plants tend to grow slowly or even die. Accordingly, in certain embodiments of the tower system of the invention, the water-quality and water-flow control system/unit, comprises: (i) at least one water pump, e.g. for pumping water from said water tank to said hording tank/reservoir, and/or to draw water from all base water tanks into a central water reservoir; (ii) at least one sensor for measuring at least one of the following parameters of the water within the water tank: pH, electric conductivity (EC), various ions' concentration, temperature, dissolved oxygen, and water level; (iii) a water treatment system (comprising, e.g. a water filter, UV light, IR light, chloride, etc.); and (iv) at least one water chiller/heater.

In certain embodiments of the tower system of the invention, the sensors within the system transmit signals to a computer, either local or a remote one, for real-time analysis and optimization of the plant's growing conditions in term of irrigation conditions such as composition of the irrigation solution, amount, fertilizers' content, pH, electrical conductivity, temperature, etc.; light conditions such as light intensity, dark-light cycle, durations, light wavelength, etc.; and gas exchange potential (e.g. humidity, O₂ and CO₂). Such real-time analysis and optimization of the growing conditions enable to grow essentially uniform plants, e.g., in term of chemical profile, and optionally physical appearance. In specific embodiments, the above data as obtained by the sensor(s) is monitored in real time by a machine learning algorithm that is constantly adapted and modified according to the type of plant being grown, growing conditions, and any other desired parameter in order to optimize and improve cultivation results.

In specific embodiments, the computer comprises a processor and memory, with a machine learning algorithm that monitors and alters all cultivation and environmental conditions, based on: pre-defined range of each measured parameter, empiric results from previous cultivation cycles, and real time processing of the plants' condition (e.g. obtained by photo images and/or sampling thereof).

In certain embodiments, the tower system of the invention further comprises a reverse osmosis water purification system that is connected either to the water tank in the base unit or to the central water reservoir, and is designed to supply water to the towers system. In specific embodiments, the reverse osmosis water purification system also serves as a water supplier when the base unit is the central reservoir.

In certain embodiments, the tower system of the invention further comprises at least one nutrients/salts/acids reservoir/cartridge and a pump associated therewith, designed to provide nutrients, salts, and/or acids into the water of the system according to need, e.g. as measured by the ion/EC/pH sensors.

In certain embodiments of the system of the invention, the sensor for detecting the water level in the central reservoir enables the system to control, e.g., water compensation flows, coming from the reverse osmosis unit into the central reservoir, according to need based on plant consumption and evaporation rates. In yet other embodiments, the system of the invention is connected to a main water system for providing water to the system when needed, e.g. due to water evaporation, plant's usage, and leakage.

In certain embodiments, the water-quality and water-flow control system/unit are located within or externally to the central water reservoir to which the circulating water drain after each irrigation round, in which case there is no water treatment/flow within the tanks of the base units, and water treatment is carried out externally to the base unit. In alternative embodiments, water-quality and water-flow control system/unit are located within each water tank within each base unit.

In certain embodiments, the water output of the system of the invention is at least 600 liter/hour, and the system further includes an oxygen sensor to measure the oxygen level within the water in the system, as well as an oxygen/air pump for adding oxygen to the water according to need. In further embodiments, the system may control the water pump(s); the diameter of the needle valve; and/or the pressure within the hording tank(s), to increase water flow velocity in the system to increase the amount of dissolved oxygen in the water.

In certain embodiments of the system of the invention, the upper hording tanks are filled by an electric/mechanic “needle valve” in order to maintain a constant and identical water level within (all) hording tanks in the system. This is essential in order to maintain constant and identical pressure, which effects water flow velocity within the tower, which effects constant irrigation to all plants in the tower system.

In order to better reduce growing area, the system of the invention can be constructed such that it has more than one growing tower. This enables to use a single base with a water tank for multiple towers, thereby saving space and reduce overall manufacturing and maintenance costs. It also enable to increase yield (e.g. by growing more plants per space). The system of the invention also aids in saving electricity costs compared to known towers, as all towers feed from the same first light source. Accordingly, in certain embodiments, the tower system of the invention comprises one, two, three, four, five or more rotatable growing hollow towers.

Lighting conditions are one of the main problems of plant growing, and insufficient lighting results in poor plant growth and reduced flowering and fruits' productions. Almost all known system use standard lighting and rely on experience and common knowledge when determining the positioning and intensity of the light source relative to the growing towers. However, this is not ideal. Accordingly, in certain embodiments, the tower system of the present invention further comprises at least one light intensity sensor and/or at least one light-distance sensor, optionally located at said one or more rotatable growing hollow towers, base unit, and/or a feeding line. This enables the system to measure the exact light intensity reaching each growing plant and in turn to adjust the lighting intensity and/or composition and/or tower location and/or orientation

In order to prevent shading of one plant over a nearby plant, it is desirable to place one plant as far away as possible from a nearby plant. This can be done by placing the plants in a zigzag orientation. Accordingly, each one of the one or more rotatable growing hollow towers of the tower system according to any of the embodiments above, comprises planting niches in a zigzag orientation from bottom to top. This further enables growing plants all around the perimeter of the tower.

In order to optimize lighting conditions while maintaining low costs and space, it is desirable to use a single lighting source for several growing towers. However, this might result in different light intensities to plants located on towers that are positioned remotely from the light source. The tower system of any one of the embodiments above overcomes this problem by placing/connecting the hollow tube (which holds the light source) to the center of the base unit, i.e. at the same distance from all surrounding rotatable growing hollow towers.

Notably, placing the first light source in a vertical position in between the growing towers enables to minimize the growing space, since the light reaches all the planting/growing niches on the tower in an even manner. This is contrary to an upper light source that requires spacing between the towers to prevent shading and to enable the light to reach lower planting/growing niches. To generate better light uniformity, superior yield consistency and quantity, a second light source provides additional lighting—at a different spectrum, coming from the tower towards the back of the plants.

As noted above, one of the disadvantages of using a powerful light source is heat generation. This raises the need to cool the environment and the plants to prevent harm and optimize growing conditions. Accordingly, in certain embodiments of the tower system of any one of the embodiments above, the passage of cool air from the environment through the hollow tube enables the delivery of heat generated by said first light source to the water in said water tank instead of to the environment, thereby enabling the water (within the water tank) to adsorb said heat for later chilling by said at least one water chiller. This eliminates the need for sophisticated and costly cooling systems, and prevents possible damage to the plants.

Moreover, in certain embodiments, the presence of the first light source within the hollow tube and the transfer of heat generated by thereby to the water in the water tank, enables placing the rotatable growing towers closer to the light source without causing heat-related damage to the plants, thereby enabling to reduce the distances between the growing towers to thereby reduce the required growing space, and electricity resources (less distance=more radiation).

Notably, heat clearance is of high agronomic significance: clearing the heat from the light source enables to decrease the minimal distance between the light source and the plant/canopy, thereby enable to reduce growing space which enables adding more plants and/or growing larger plants in a given area (bigger plants have larger yields).

In specific embodiments, the present invention provides a vertical hydroponically plant-growing tower system comprising: (a) a base unit comprising a water tank, wherein said water tank is designed to be connected to a water tank(s) of a nearby parallel tower system(s); (b) a water-quality and water-flow control system/unit, comprising: (i) at least one water pump; (ii) at least one sensor for measuring at least one of the following parameters of the water within the water tank: pH, electric conductivity (EC), and temperature; (iii) a water treatment system comprising, e.g., a water filter, UV, IR, etc.; and (iv) at least one water chiller/heater; (c) one (three) or more rotatable growing hollow towers having planting niches in a zigzag orientation (to prevent shading of one plant over the other) from bottom to top, each growing tower has a hording tank/reservoir at its top (i.e. located above the highest planting niche) from which water flow over the inner wall of the tower, i.e. within the hollow tower across said planting niches and through the roots of the plants in each niche, wherein: (i) said at least one water pump is designed to pump water from said water tank into said hording tank/reservoir; and (ii) said growing hollow towers can be rotated to thereby enable access to the planting niches located on all sides of the growing tower and rotate back toward the light source located in between the towers; (d) a hollow tube connected to the base unit at its center, said hollow tube having an opening at its top allowing air to enter the tube, and a bottom opening allowing the air to flow through the tube and onto the water within said water tank; (e) a first light source located within said hollow tube; (f) a second light source associated/located onto each one of said one or more growing towers, such as strips of lamps around each tower; and (g) at least one ventilation unit designed to push air through the upper opening of said hollow tube across said first light source and into said water tank; wherein the passage of air through the hollow tube enables delivering any heat that might be generated by said first light source to the water in said water tank instead of to the environment, thereby enabling the water to adsorb said heat for later chilling by said at least one water chiller/heater.

In specific embodiments, the tower system of the invention comprises one, two, three, four, five or more rotatable growing towers connected to a single base unit.

In certain embodiments, when the tower system of the invention is installed in a greenhouse, the towers may be rotated during daytime so that the plants are faced outwardly, i.e. towards the sun (in order to save electricity by shouting the light source off), and rotated back towards the first light source if the light sensor(s) detects a low sunlight intensity (due to clouds or nightfall) to provide the full light period needed to the plants.

In specific embodiments, the rotating growing towers constantly rotate in order to expose all the planting/growing niches on the tower to the first light source. This enables planting plants in all niches of the tower, even those located on the dark side of the tower (i.e. not on the side facing the first light source).

The tower system of any one of the embodiments above is designed to maximize plant growth per square meter, reduce electricity resources, reduce irrigation water resources, reduce human/labor resources (HR). The tower system of the invention is further designed to enable evenly produced plants with minimum to no differences (in term of, e.g., quality and chemical content) between the grown plants, even in different towers and different planting niches.

In certain embodiments, the tower system of any one of the embodiments above is designed to maintain the following growing parameters identical for all the plants grown in the planting/growing niches thereof: irrigation conditions such as composition of the irrigation solution, amount, fertilizers' content, pH, electrical conductivity, temperature, etc.; light conditions such as light intensity, dark-light cycle, durations, light wavelength, etc.; and gas exchange potential (e.g. humidity, O₂ and CO₂), thereby enabling the production of essentially uniform plants, e.g., in term of chemical profile, and optionally physical appearance. In specific embodiments, these parameters are monitored in real time by a machine learning algorithm that is constantly adapted and modified according to the type of plant being grown, growing conditions, and any other desired parameter.

The present invention further provides a method for maximizing plant growth per square meter, the method comprising the steps of: (i) providing a tower system according to any one of the embodiments above; (ii) filling water in the water tank; (iii) placing/planting plants/seeds/cuttings within the planting niches; (iv) turning the tower system on to thereby: enable water flow from the (e.g. central) water tank to the hording tank/reservoir; activating the light source(s); and activating the ventilation unit and the water chiller/heater; thereby enabling optimized plant growth per square meter.

The present invention further provides a method for germinating seeds, the method comprising the steps of: (i) providing a tower system according to any one of the embodiments above; (ii) filling water in the water tank; (iii) placing seeds within the planting niches, optionally by using a seeding medium; (iv) turning the tower system on to thereby: enable water flow from the (e.g. central) water tank to the hording tank/reservoir; activating the light source(s); and activating the ventilation unit and the water chiller/heater; thereby enabling seed growth.

In certain embodiments, the methods of the invention further comprises a step of maintaining the water level within (all) hording tanks in the system constant and identical in order to maintain constant and identical pressure therein, to thereby maintain constant and identical water flow velocity, within all the growing towers in the system, as well as optimal levels of dissolved oxygen in the water.

In yet another embodiments, the method of the invention further reduces electricity usage, and the required amount of irrigation water and human/labor resources (HR). It should be noted that the reduction in HR costs is possible since minimal handling of the plants is needed throughout the growth cycle. In addition, no need for cumbersome movements of the plants from place to place (which is usually needed when the plants grow and have different requirements that forces their displacement and moving).

In certain embodiments of the method of the above embodiments, the intensity and/or composition of the light source(s) and the duration of their activation, are determined according to the physical distance of the light source from the plant's canopy, the plant type, and according to plant's growing stage. For instance, for cannabis plants, during the germination stage there is no need for light; during the growth stage: 18 hours of daylight (mostly “blue” spectrum); and for the blossom stage 12 hours of daylight (mostly “red” spectrum).

In certain embodiments of the method of the above embodiments, the first and second light sources are activated together, or interchangeably, and/or according to the plants' different growth stages. For instance, only the second light source is used for the rooting of cuttings.

In certain embodiments, the second light source may serve also as a pest repellant, e.g. by using special wavelength or light (such as infrared).

In certain embodiments, the methodology of changing from one light source to the other, and/or light composition, for different plant's growth stages without moving the plant itself, enables “best practice” operation and compliance with QA/GMP standards, since the plants are not moved from their spot throughout their life cycle, which lowers the probability for contaminations and damage to the plants. This also reduces labor and the work needed during grow.

In certain embodiments of the method of the above embodiments, the intensity of the light source(s) and the duration of their activation, and the light composition, are determined according to the need to reduce/induce plant stress.

In certain embodiments, the method of the above embodiments further comprises a step of controlling the temperature of the system and the environment. It should be noted that the term “environment” as used herein refers to temperature, humidity, light intensity, CO₂ concentration, O₂ concentration, air flow velocity, etc. in the grow facility/greenhouse.

In certain embodiments of the method of the above embodiments, the temperature and other environmental parameters are determined according to the plant type and according to plant's growing stage. For instance, during the growth stage of cannabis: 23-29° C. during the light period, and 16-20° C. during the dark period.

In certain embodiments of the method of the above embodiments, the humidity and CO₂ levels, as well as the EC, pH, dissolved oxygen and ion concentration of the water are determined according to the plant type and according to plant's growing stage.

In certain embodiments of the method of the invention, the sensors within the system transmit signals to a computer, either local or a remote one, for real-time analysis and optimization of the plant's growing conditions in term of irrigation conditions such as composition of the irrigation solution, amount, fertilizers' content, pH, electrical conductivity, temperature, etc.; environment conditions such as temperature and humidity; light conditions such as light intensity, dark-light cycle, durations, light wavelength, etc.; and gas exchange potential (e.g. humidity, O₂ and CO₂). Such real-time analysis and optimization of the growing conditions enable to grow essentially uniform plants, e.g., in term of chemical profile, and optionally physical appearance. In specific embodiments, the above data as obtained by the sensor(s) is monitored in real time by a machine learning algorithm that is constantly adapted and modified according to the type of plant being grown, growing conditions, and any other desired parameter in order to optimize and improve cultivation results.

In specific embodiments of the method of the invention, a machine learning algorithm within the computer monitors and alters all cultivation and environmental conditions, based on: pre-defined range of each measured parameter, empiric results from previous cultivation cycles, genetic data of the plant species grown, and real time processing of the plants' condition (e.g. obtained by photo images and/or sampling thereof).

Accordingly, in certain embodiments of the method of the invention for hydroponically growing plants, all growing parameters within the system during the growing of the plants are controlled by a computer based on data received from sensors within the system. In further specific embodiments, all the following growing parameters are maintained identical for all plants grown therein: irrigation conditions, environment conditions; light conditions, and gas exchange potential, thereby enabling production of essentially uniform plants.

The invention will now be illustrated by the following non-limiting examples with reference to the accompanying figures.

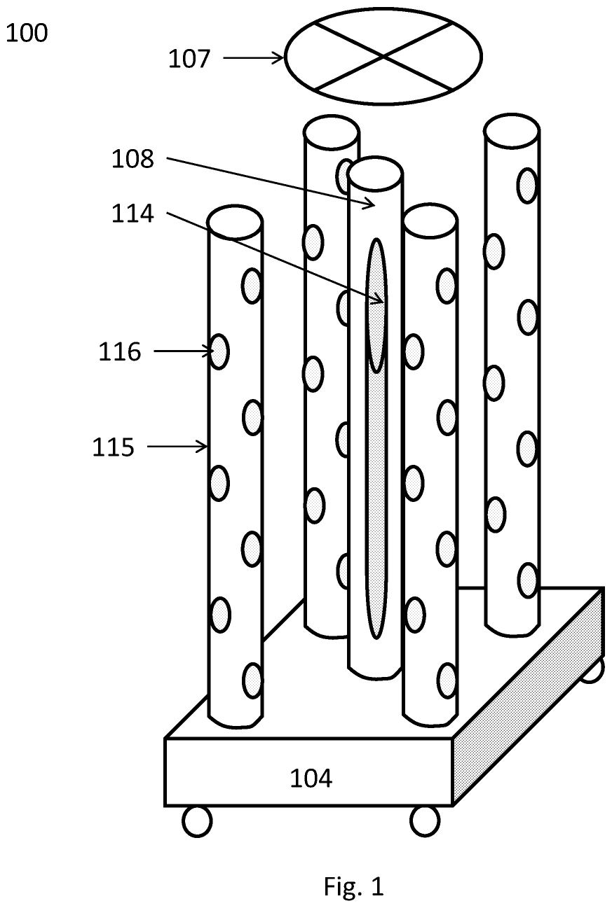

FIG. 1 illustrates a tower unit according to the invention, in which the base unit 104 comprises wheels; the system comprises four rotating growing towers 115 with planting niches 116 in zigzag orientation. At the center of the base unit 104 is a hollow tube 108 holding a first light source 114, and above the upper opening of the hollow tube 108 there is a venting unit 107 for pushing air through the hollow tube 108, over the first light source 114, and onto the water within the base unit water tank 104 to thereby deliver any heat generated by the first light source 114 to the water. Notably, the exemplified tower unit may stand on its own or be connected to similar tower units to create a hydroponic vertical tower growing system that comprises multiple tower units according to user's need.

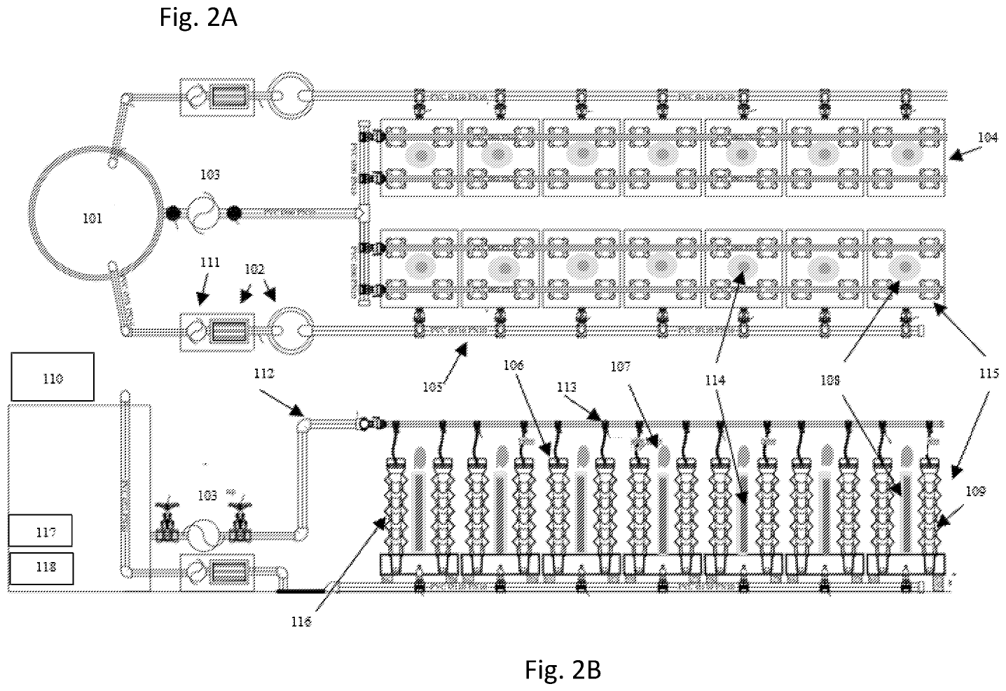

FIGS. 2A and 2B are illustrations (upper- and side-views) of an exemplary tower system according to the invention comprising multiple tower units each comprises four rotating growing towers 115. FIGS. 2A and 2B show various components of the system, including: a main water reservoir 101; a water treatment unit 102; a first water pump 103; a base unit water tank 104; a collecting line 105; upper hording tank/reservoir 106; ventilation unit 107; hollow tube 108; second light source 109; reverse osmosis unit 110; a second water pump 111; feeding line 112; needle valve 113; first light source 114; rotatable growing hollow towers 115; planting niches 116; chiller/heater 117; and nutrients pump 118.

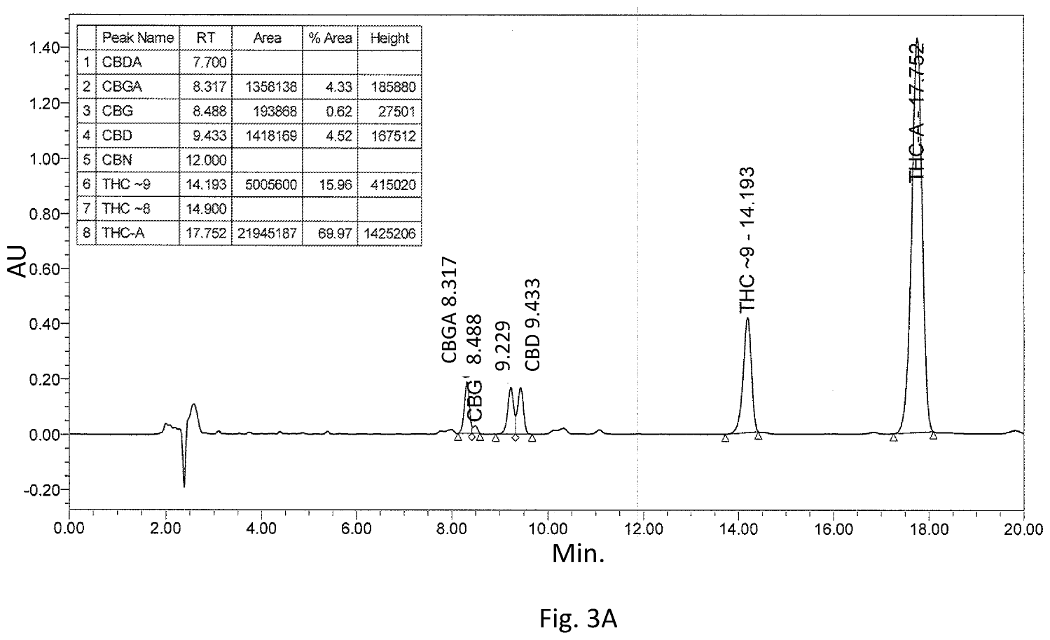

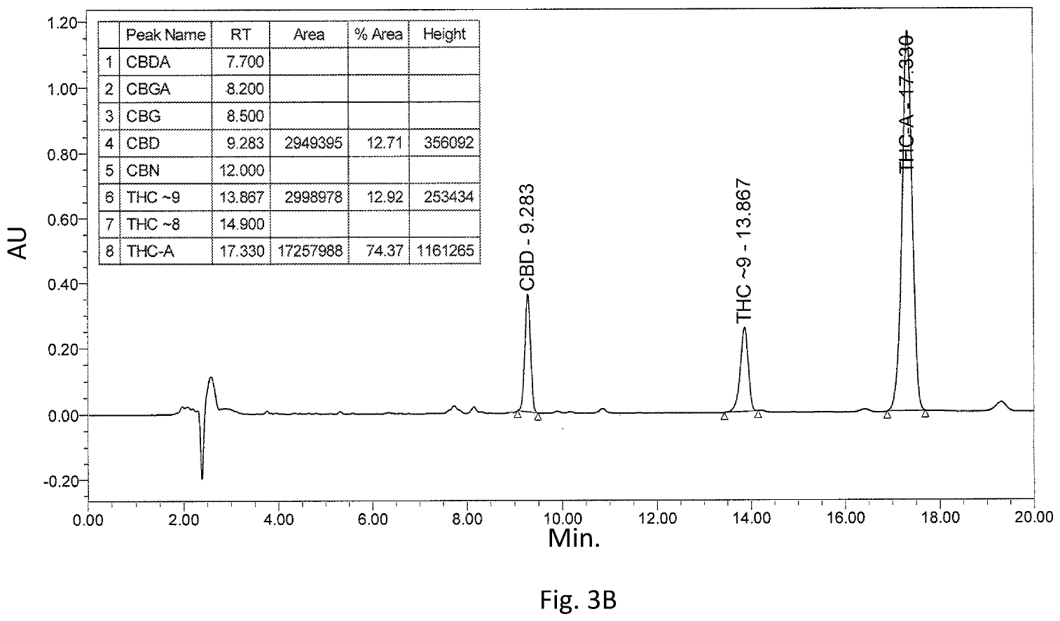

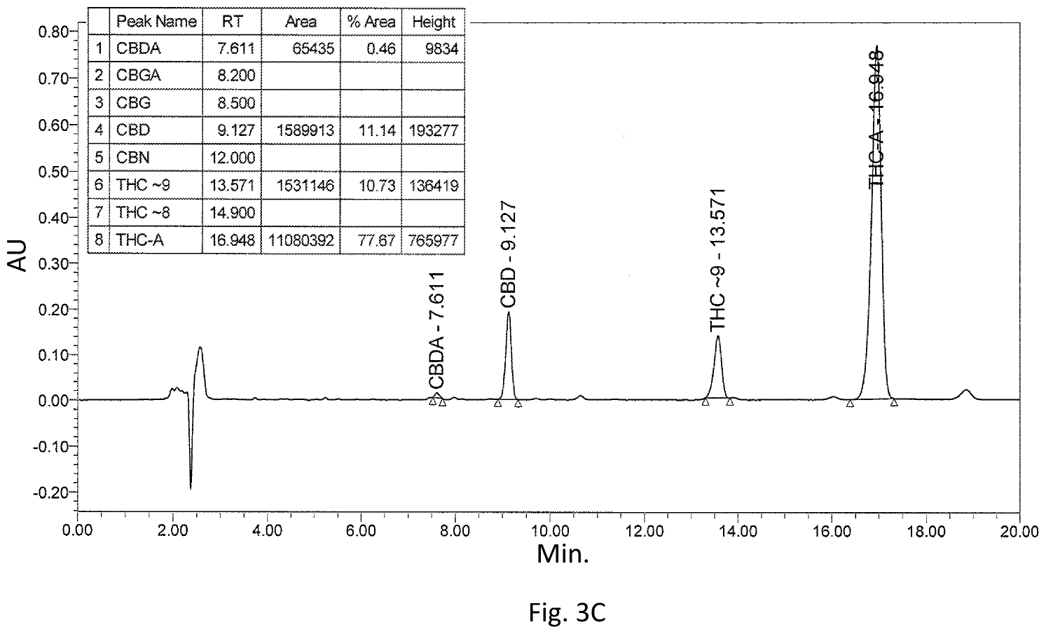

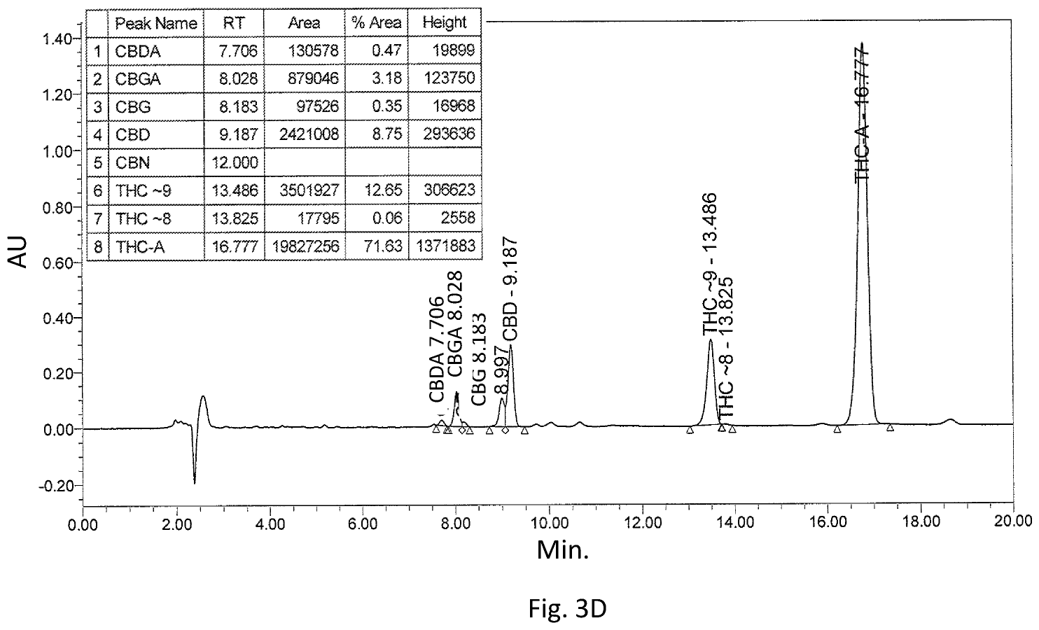

FIGS. 3A-3D are HPLC analysis results of four different cannabis plants grown: the first is of plant grown in standard known hydroponic system and used as a reference, and each of the other three is grown on a different growing tower 115 in the same system 100. The following components have been identified in all four plants: CBDA, CBGA, CBG, CBD, CBN, THC-9, THC-8 and THC-A. Each graph is accompanied with an insert table showing the calculated area under the peak for each of the above components. As illustrated by the HPLC results, the three plants grown in the present system 100 demonstrated an essentially same chemical profile with minimal abbreviations in the essential required components, i.e., CBD, THC-9 and THC-A. Moreover, they presented higher levels of CBD (about 140% more) and THC-A (about 6.5% more).

TABLE 1

| Peak | % Area | % | % | % | % Area Ave. |
|---|---|---|---|---|---|
| name | Control | Area 1 | Area 2 | Area 3 | (1-3) |
| CBDA | | | 0.46 | 0.47 | |
| CBGA | 4.33 | | | 3.18 | |
| CBG | 0.62 | | | 0.35 | |
| CBD | 4.52 | 12.71 | 11.14 | 8.75 | 10.86 |
| CBN | | | | | |
| THC-9 | 15.96 | 12.92 | 10.73 | 12.65 | 12.1 |
| THC-8 | | | | 0.06 | |
| THC-A | 69.97 | 74.37 | 77.67 | 71.63 | 74.56 |

1. A vertical hydroponically plant-growing tower system comprising:
a central water reservoir;
a base unit comprising a water tank;
a water-quality and water-flow control system;
a hollow tube connected to the base unit, said hollow tube having an opening at its top allowing air to enter the tube, and a bottom opening allowing the air to flow through the tube and onto the water within said water tank;
a first light source located within said hollow tube;
a second light source located onto each one of said one or more growing towers designed to provide additional lighting coming from the tower towards the back of the plants;
at least one ventilation unit designed to push air through the upper opening of said hollow tube across said first light source and into said water tank; and
one or more rotatable growing hollow towers having planting niches, each growing tower has a hording reservoir at its top from which water flow over the inner wall of the tower across said planting niches,
wherein said growing hollow towers can be rotated to thereby enable access to the planting niches located on all sides of the growing tower.

2. The tower system of claim 1, wherein said water tank is designed to be connected to a water tank(s) of a nearby parallel tower system(s).

3. The tower system of claim 1, wherein said water-quality and water-flow control system, comprises:
at least one water pump for pumping water from said water tank to said hording reservoir, and/or to draw water from all base water tanks into a central water reservoir;
at least one sensor for measuring at least one of the following parameters of the water within the water tank: pH, electric conductivity, various ions concentration, temperature, dissolved oxygen, and water level;
a water treatment system comprising at least one of: a water filter, UV-light source, IR-light source, chloride addition mechanism, or any combination thereof; and
at least one water chiller/heater.

4. The tower system of claim 3, wherein said at least one sensor transmits signals to a computer for real-time analysis and optimization of growing conditions in term of irrigation conditions, environment conditions, light conditions, gases and fertilization.

5. The tower system of claim 1, further comprising a reverse osmosis water purification system.

6. The tower system of claim 1, further comprising at least one nutrients/salts/acids reservoir and a pump associated therewith, designed to provide said nutrients/salts/acids into the water according to need.

7. The tower system of claim 1, comprising one, two, three, four, five or more rotatable growing hollow towers associated with the same base unit.

8. The tower system of claim 1, further comprising at least one light intensity and/or at least one light-distance sensor, optionally located at said one or more rotatable growing hollow towers and/or said base unit.

9. The tower system of claim 1, wherein each one of said one or more rotatable growing hollow towers comprises planting niches in a zigzag orientation.

10. The tower system of claim 1, wherein said hollow tube is connected to the base unit at its center, i.e. at the same distance from all the surrounding rotatable growing hollow towers.

11. The tower system of claim 1, wherein the passage of air through the hollow tube enables the delivery of heat generated by said first light source to the water in said water tank, thereby enabling the water to adsorb said heat for later chilling by said at least one water chiller.

12. A vertical hydroponically plant-growing tower system comprising:
a base unit comprising a water tank,
wherein said water tank is designed to be connected to a water tank(s) of a nearby parallel tower system(s);
a water-quality and water-flow control system, comprising:
at least one water pump;
at least one sensor for measuring at least one of the following parameters of the water within the water tank: pH, electric conductivity (EC), and temperature;
a water treatment system; and
at least one water chiller/heater;
one or more rotatable growing hollow towers having planting niches in a zigzag orientation, each growing tower has a hording reservoir at its top from which water flow over the inner wall of the tower across said planting niches, wherein:
said at least one water pump is designed to pump water from said water tank into said hording reservoir; and
said growing hollow towers can be rotated to thereby enable access to the planting niches located on all sides of the growing tower;
a hollow tube connected to the base unit at its center, said hollow tube having an opening at its top allowing air to enter the tube, and a bottom opening allowing the air to flow through the tube and onto the water within said water tank;
a first light source located within said hollow tube;
a second light source located onto each one of said one or more growing towers; and
at least one ventilation unit designed to push air through the upper opening of said hollow tube across said first light source and into said water tank;
wherein:
the passage of air through the hollow tube enables delivering any heat that might be generated by said first light source to the water in said water tank instead of to the environment, thereby enabling the water to adsorb said heat for later chilling by said at least one water chiller/heater.

13. The tower system of claim 1, wherein the upper hording tanks are designed to maintain a constant and identical water pressure, to thereby enable equal water flow velocity within all towers in the system and thereby facilitate constant irrigation to all plants in all the towers in the system.

14. The tower system of claim 1, which is designed to maximize plant growth per square meter, reduce electricity resources, reduce irrigation water resources, and reduce human/labor resources.

15. The tower system of claim 1, wherein all the following growing parameters are maintained identical for all the plants grown therein: irrigation conditions, light conditions, and gas exchange potential, thereby enabling production of essentially uniform plants.

16. A method for maximizing plant growth per square meter, the method comprising the steps of:
(i) providing a tower system according to claim 1;
(ii) filling water in the water tank;
(iii) placing/planting plants/seeds/cuttings within the planting niches;
(iv) turning the tower system on to thereby:
enable water flow from the water tank to the hording reservoir;
activating the light source(s); and
activating the ventilation unit and the water chiller/heater;
thereby enabling maximized plant growth per square meter.

17. The method of claim 16, which further reduces electricity usage, and the required amount of irrigation water and HR/labor resources.

18. The method of claim 16, wherein the intensity and composition of the light source(s) and the duration of their activation, are determined according to the physical distance of the light source from the plant's canopy, the plant type, and according to plant's growing stage.

19. The method of claim 16, wherein the first and second light sources are activated together, or interchangeably, and/or according to the plants' different growth stages.

20. The method of claim 16, wherein the intensity and composition of the light source(s) and the duration of their activation, are determined according to the need to reduce/induce plant stress.

21. The method of claim 16, further comprising a step of controlling the temperature of the system, and the environment.

22. The method of claim 16, wherein the humidity and CO₂ levels, as well as the EC, pH, dissolved oxygen and ion concentration of the water are determined according to the plant type and according to plant's growing stage.

23. The method of claim 22, wherein the following growing parameters: temperature humidity, CO₂ levels, EC, pH, dissolved oxygen and ion concentration of the water, and any other environmental parameter, are determined according to the plant type and according to plant's growing stage.

24. The method of claim 23, wherein said growing parameters within the system during the growing of the plants are controlled by a computer based on data received from sensors within the system.

25. The method of claim 16, wherein all the following growing parameters are maintained identical for all plants grown therein: irrigation conditions, environment conditions, light conditions, and gas exchange potential, thereby enabling production of essentially uniform plants.
